(19) United States
(12) Patent Application Publication
(10) Pub. No.: US 2005/0140258 A1
(43) Pub. Date: Jun. 30, 2005

(54) Backlight assembly with diffusion sheet having diffraction gratings

(75) Inventors: Charles Leu, Fremont, CA (US); Tai-Cherng Yu, Tu-Cheng (TW); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/972,516

(22) Filed: Oct. 25, 2004

(30) Foreign Application Priority Data
Dec. 31, 2003 (TW) 92137545

(51) Int. Cl. H01K 1/30; H01J 5/16; H01J 61/40

(52) U.S. Cl. 313/110; 313/113

(57) ABSTRACT

A backlight assembly (100) for providing bright and uniform light beams to illuminate an LCD panel includes a light source (120), a reflector (130), and a diffusion sheet (150). The light source is positioned between the reflector and the diffusion sheet, and the diffusion sheet has at least one diffraction grating (151) formed on a surface thereof facing the light source. The backlight assembly has a simple configuration for providing bright and uniform light beams to illuminate an LCD panel. Furthermore, the diffusion sheet is made of a transparent piezoelectric material. When an electric field is applied on the diffusion sheet by a controlling circuit, the diffusion sheet is induced to deform. Thus the distribution of light intensity can be modulated according to need.

### BACKGROUND OF THE INVENTION

1. Field of the Invention

The present invention relates to a backlight assembly for liquid crystal display (LCD) devices, and more particularly to a direct type backlight assembly employing a diffusion sheet with a plurality of diffraction gratings.

2. Description of the Prior Art

A typical LCD device comprises an LCD panel, and a backlight system mounted under the LCD panel for supplying light beams thereto. There are two types of backlight systems: the edge type and the direct type. The edge type backlight system mainly comprises a light guide plate, and a light source disposed adjacent to a thin side of the light guide plate. The light guide plate is used for guiding the light beams emitted by the light source to uniformly illuminate the LCD panel.

In contrast, the direct type backlight system employs light sources placed in an air-filled cavity under the LCD panel, and a diffuser disposed between the LCD panel and the light sources.

Referring to FIG. 5, U.S. Pat. No. 5,479,328 discloses a direct type backlight 10 that includes a reflector 14, a serpentine fluorescent tube 12, a glass substrate 15, a diffuser 17, a brightness enhancement film (BEF) 18, an air gap 19, and an LCD panel 20. The glass substrate 15, the diffuser 17, and the BEF 18 cooperatively combine to form an image plate. Many of the light beams emitted by the tube 12 are directly emitted to the image plate, and the remainder of the light beams emitted by the tube 12 are reflected to the image plate by the reflector 14. In this manner, a bright and uniform image is formed at the image plate.

However, the configuration of the direct type backlight is unduly complicated. The tube 12 is a fluorescent tube having a circular cross section. The tube 12 is one hundred inches long, and has ten straight, parallel segments with nine 180-degree U-bends. Correspondingly, the reflector 14 has ten channels receiving the straight segments. In addition, the manufacturing process of the reflector 14 is complicated and laborious, because of the need for the channels and the need for attaining high reflectivity. The steps involved in the manufacturing process comprise: cutting a workpiece to form the channels; polishing the workpiece; and silver coating the workpiece.

Therefore it is desired to provide a new kind of direct type backlight which can introduce bright and uniform light beams to illuminate an LCD panel, and which can overcome the above-described disadvantages of a conventional direct type backlight.

### SUMMARY OF THE INVENTION

An object of the present invention is to provide a backlight assembly having a simple configuration, and which can introduce bright and uniform light beams to illuminate an LCD panel.

In order to achieve the above-described object, a backlight assembly in accordance with the present invention includes a light source, a reflector, and a diffusion sheet. The light source is positioned between the reflector and the diffusion sheet, and the diffusion sheet has at least one diffraction grating formed on a surface thereof facing the light source. The backlight assembly has a simple configuration for providing bright and uniform light beams to illuminate an LCD panel. Furthermore, the diffusion sheet is made of a transparent piezoelectric material. When an electric field is applied on the diffusion sheet by a controlling circuit, the diffusion sheet is induced to deform. Thus the distribution of light intensity can be modulated by the controlling circuit according to need.

Other objects, advantages, and novel features of the present invention will become more apparent from the following detailed description when taken in conjunction with the accompanying drawings.

### BRIEF DESCRIPTION OF THE DRAWINGS

FIG. 1 is an exploded, isometric view of a backlight assembly in accordance with the present invention.

FIG. 2 is a bottom plan view of a diffusion sheet of the backlight assembly of FIG. 1.

FIG. 3 is an enlarged, side plan view of part of the diffusion sheet of the backlight assembly of FIG. 1, showing essential optical paths of light beams transmitting through a diffraction grating of the diffusion sheet.

FIG. 4 is essentially an assembled, side plan view of the backlight assembly of FIG. 1, showing essential optical paths thereof.

FIG. 5 is an exploded, cross-sectional view of a conventional backlight assembly.

### DETAILED DESCRIPTION OF THE PRESENT INVENTION

Reference now will be made to the drawings to describe the present invention in detail.

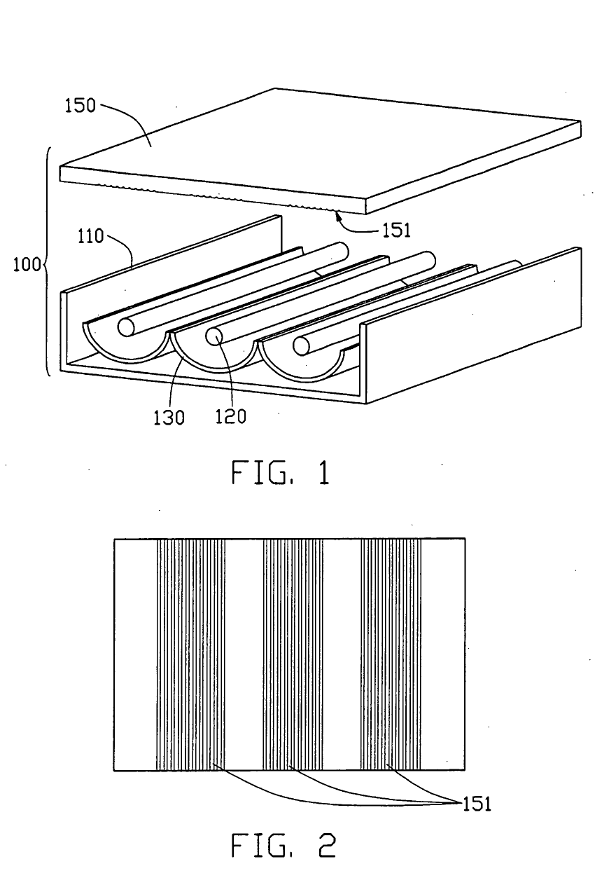

Referring to FIG. 1, an exemplary backlight assembly 100 of the present invention comprises a housing 110, a reflector 130 received in the housing 110, a plurality of light source tubes 120 located in the housing 110 above the reflector 130, and a diffusion sheet 150 located above the housing 110. The tubes 120 are normal, linear cold cathode fluorescent tubes (CCFLs) 120. The reflector 130 has several parallel, contiguous arcuate portions (not labeled), each arcuate portion corresponding to a respective tube 120.

Referring to FIG. 2, a bottom plan view of the diffusion sheet 150 is shown. The diffusion sheet 150 has several separate transmission diffraction gratings 151. In the exemplary embodiment, the diffraction gratings 151 are integrally formed as part of the diffusion sheet 150. Each diffraction grating 151 is opposite to a respective tube 120. The diffusion sheet 150 is made of a transparent piezoelectric material, such as a transparent piezoelectric ceramic or polyvinylidene fluoride (PVDF). The diffusion sheet 150 is connected to an outer controlling circuit (not shown), to electrically control deformation of the diffusion sheet 150. Because the diffusion sheet 150 is made of the piezoelectric material, which has the characteristic of electromechanical coupling, the diffusion sheet 150 is induced to mechanically deform when an electric field is applied.

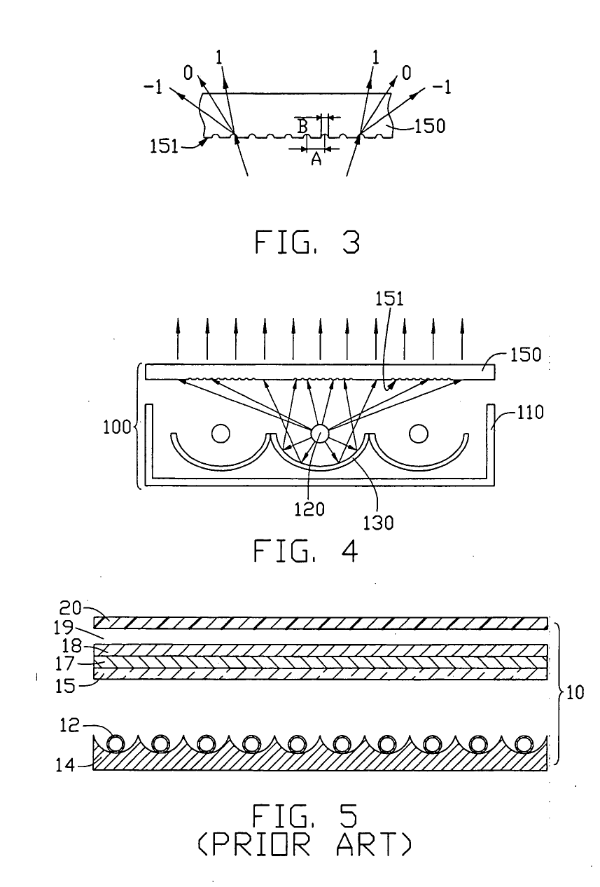

FIG. 3 is an essential optical paths diagram of light beams transmitting through the diffusion sheet 150 at any one of the diffraction gratings 151. A pitch between each two adjacent lines of the diffraction grating 151 is defined as A, and a width of each line of the diffraction grating 151 is defined as B. A is in the range from 10 um to 30 um, and B is in the range from 1 um to 10 um.

When light beams pass through the diffraction grating 151, a multiple diffraction effect is produced. The following describes a characteristic of the distribution of light intensity due to the diffraction effect. One light beam is split into many light beams by passing through the diffraction grating 151. Said many light beams comprise ±1st order beams, ±2nd order beams (not shown), ±3rd order beams (not shown) through to ±nth order beams (not shown), with these beams being respectively distributed at opposite sides of the zeroth order beam. The combination of the zeroth order beam, the ±1st order beams, the ±2nd order beams through to the ±nth order beams enlarges the radiation angle of the light beam passing through the diffraction grating 151. This improves the uniformity of illumination provided by the tubes 120.

Referring to FIG. 4, in operation, many of the light beams emitted by the tubes 120 are directly emitted to the diffusion sheet 150, and substantially the entire remainder of the light beams emitted from the tubes 120 are reflected to the diffusion sheet 150 by the reflector 130. Therefore almost all the light beams emitted by the tubes 120 are transmitted to the diffusion sheet 150. Accordingly, an irradiance of light is higher at the diffraction gratings 151 than at other portions of the diffusion sheet 150 between the diffraction gratings 151. The diffraction gratings 151 diffuse the light beams received thereat, thereby counteracting the disparity of intensity of light beams irradiating the diffusion sheet 150. This improves the uniformity of irradiance provided by the backlight assembly to illuminate an LCD panel (not shown).

Furthermore, the distribution of light intensity due to the diffraction effect can be modulated. When an electric field (not shown) is applied on the diffusion sheet 150 by the controlling circuit, the diffusion sheet 150 is induced to deform. The pitch A and the width B of the diffraction gratings 151 vary according to the voltage used to generate the electric field. In particular, the width B increases with increasing voltage. In such case, more light beams can pass through the lines of the diffraction gratings 151.

In summary, the present invention has a simple configuration, comprising the normal linear tubes 120 and the diffusion sheet 150 with the diffraction gratings 151. The configuration provides bright and uniform light beams to illuminate an LCD panel. In particular, the diffraction gratings 151 are disposed corresponding to the tubes 120. The diffraction gratings 151 diffuse light beams received from the tubes 120, and counteract the disparity of intensity of light beams that reach the diffusion sheet 150. Furthermore, the distribution of light intensity can be modulated by the controlling circuit according to need.

Various modifications and alterations are possible within the ambit of the invention herein. For example, the diffraction gratings 151 can be provided by way of an optical film being adhered to a surface of the diffusion sheet 150, with the optical film having diffraction grating structures therein. Moreover, the reflector 130 can have a reflective film (not shown) coated on a surface thereof that is opposite to the diffusion sheet 150. The reflective film preferably has a reflective ratio greater than 98%.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A backlight assembly, comprising:
a light source;
a reflector; and
a diffusion sheet;
wherein, the light source is positioned between the reflector and the diffusion sheet, and the diffusion sheet has at least one diffraction grating formed on a surface thereof facing the light source.

2. The backlight assembly as claimed in claim 1, wherein a pitch between each two adjacent lines of said diffraction grating is in the range from 10 um to 30 um.

3. The backlight assembly as claimed in claim 2, wherein a width of each line of said diffraction grating is in the range from 1 um to 10 um.

4. The backlight assembly as claimed in claim 3, wherein the diffusion sheet is made of a transparent piezoelectric material.

5. The backlight assembly as claimed in claim 4, wherein the pitch and the width vary according to an electric field applied to the diffusion sheet.

6. The backlight assembly as claimed in claim 4, wherein the transparent piezoelectric material is a transparent piezoelectric ceramic.

7. The backlight assembly as claimed in claim 4, wherein the transparent piezoelectric material comprises polyvinylidene fluoride.

8. The backlight assembly as claimed in claim 1, wherein the light source includes a plurality of cold cathode fluorescent tubes.

9. The backlight assembly as claimed in claim 1, wherein the reflector includes a reflective film coated on a surface thereof facing the diffusion sheet, the reflective film having a reflective ratio greater than 98%.

10. The backlight assembly as claimed in claim 1, further comprising a housing receiving the reflector therein.

11. A backlight assembly, comprising:
a light source;
a reflector; and
a diffusion sheet;
wherein, the light source is positioned between the reflector and the diffusion sheet, an optical film is provided on a surface of the diffusion sheet facing the light source, and the optical film comprises as plurality of diffraction grating structures.

12. A backlight assembly, comprising:
a light source;
a liquid crystal display (LCD) panel formed next to said light source and facing said light source to receive light from said light source;
a reflector next to said light source to reflect light from said light source toward said LCD panel;
at least one set of transmission diffraction gratings interferingly located between said light source and said LCD panel to diffuse said light from said light source and reflected light of said light from said reflector before reaching of said light and said reflected light to said LCD panel.

13. The backlight assembly as claimed in claim 12, wherein said at least one set of transmission diffraction gratings is formed on a diffusion sheet located between said light source and said LCD panel.

14. The backlight assembly as claimed in claim 12, further comprising another spaced light source disposed in a plane having said light source and parallel to said LCD panel, and one of said at least one set of transmission diffraction gratings located between said LCD panel and said another light source as well as said light source.
